(19) United States
(12) Patent Application Publication
(10) Pub. No.: US 2009/0180655 A1
(43) Pub. Date: Jul. 16, 2009

(54) PACKAGE FOR MEMS MICROPHONE

(75) Inventors: Jiung-Yue TIEN, Taichung County (TW); Hsin-Tao Yang, Taichung City (TW)

Correspondence Address: BROWDY AND NEIMARK, P.L.L.C.;624 NINTH STREET, NW, SUITE 300, WASHINGTON, DC, 20001-5303, US

(73) Assignee: LINGSEN PRECISION INDUSTRIES, LTD., Taichung (TW)

(21) Appl. No.: 12/262,939

(22) Filed: Oct. 31, 2008

(30) Foreign Application Priority Data
Jan. 10, 2008 (TW) 97200632

(51) Int. Cl. H04R 3/00

(52) U.S. Cl. 381/361

(57) ABSTRACT

A package for a MEMS microphone includes a cover, a substrate connected with the cover to define with the cover an accommodation chamber and having a channel in communication between the accommodation chamber and the space outside the cover, and a single chip disposed in the accommodation chamber and electrically connected with the substrate and corresponding to the channel of the substrate. Thus, an acoustic single can enter the accommodation chamber to reach the single chip through the channel for minimizing the dimensions of the package of the present invention.

### BACKGROUND OF THE INVENTION

1. Field of the Invention

The present invention relates generally to a MEMS microphone, and more specifically to a package for a MEMS microphone that has small dimensions.

2. Description of the Related Art

U.S. Pat. No. 6,781,231 discloses a microelectromechanical system package comprising surface mountable components including MEMS devices, e.g. a transducer, a silicon-based microphone, integrated circuits and the like, a substrate, and a cover. The cover is connected to the substrate to form a chamber for accommodation of the surface mountable components. An acoustic signal is allowed to reach the surface mountable components through an acoustic port located on a top surface of the cover.

However, because the chamber needs enough space to accommodate the surface mountable components, and the top surface of the cover needs to be spaced at a certain distance from the surface mountable components for allowing the acoustic signal to reach the surface mountable components, the cover will have big dimensions to increase the overall dimensions of the microelectromechanical system package.

### SUMMARY OF THE INVENTION

The present invention has been accomplished in view of the above-noted circumstances. Therefore, the primary objective of the present invention is to provide a package for a MEMS microphone, which can reduce its overall dimensions.

The foregoing objectives of the present invention is attained by the package comprising a cover, a substrate connected with the cover to define with the cover an accommodation chamber and having a channel in communication between the accommodation chamber and the space outside the cover, and a single chip disposed in the accommodation chamber and electrically connected with the substrate and corresponding to the channel of the substrate.

As a result, an acoustic signal can enter the accommodation chamber to reach the single chip through the channel, thereby minimizing the overall dimensions of the package of the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a schematic drawing of the package according to a first preferred embodiment of the present invention, and

FIG. 2 is a schematic drawing of the package according to the second preferred embodiment of the present invention.

### DETAILED DESCRIPTION OF THE INVENTION

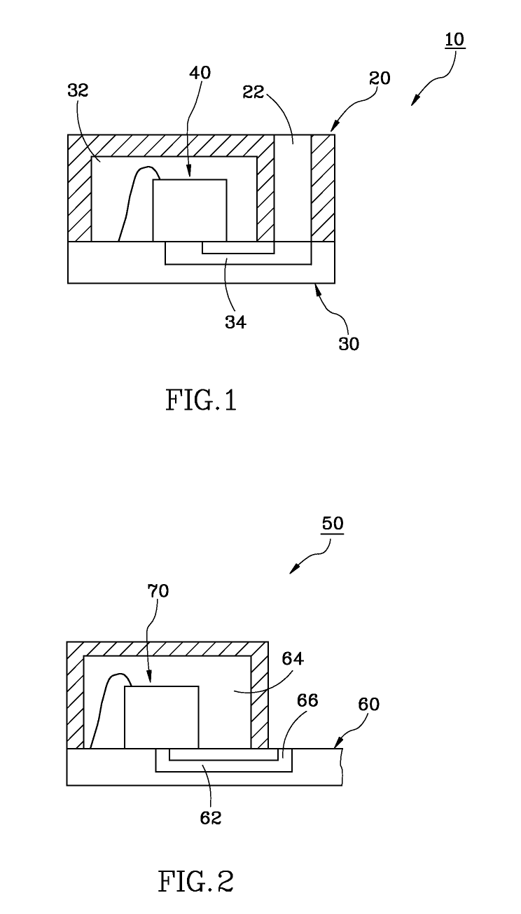

As shown in FIG. 1, a package 10 for a MEMS microphone in accordance with a first preferred embodiment of the present invention comprises a cover 20, a substrate 30, and a single chip 40.

The cover 20, which is made of nonmetal, has an acoustic hole 22 in communication with the space outside the cover 20.

The substrate 30 has a top surface thereof connected with the cover 20 so as to define with the cover 20 an accommodation chamber 32. In this embodiment, the substrate 30 has a channel 34 with one end thereof in communication with the space outside the cover 20 through the acoustic hole 22 and the other end thereof in communication with the accommodation chamber 32 such that an acoustic single can enter the accommodation chamber 32 through the acoustic hole 22 and the channel 34.

The single chip 40 is disposed in accommodation chamber 32 and electrically connected with the substrate 30 and corresponding to one end of the channel 34 of the substrate 30 such that the single chip 40 can receive the acoustic single entering the accommodation chamber 32 and transfer the acoustic single to an electric single by a passive component (not shown) of the single chip 40 and convey the electric single through the substrate 30.

By means of the aforesaid design, because the passive component is integrated into the single chip 40 such that the package 10 of the present invention doesn't need too much space to accommodate the single chip 40, i.e. the length and the width of the cover 20 can be minimized. Further, the location of the single chip 40 is near to one end of the channel 34 for receiving the acoustic single entering the accommodation chamber 32 through the channel 34 such that the distance between the cover 20 and the substrate 30 can be reduced, i.e. the height of the cover 20 can be minimized. As a result, the overall dimensions of the package 10 of the present invention can be effectively minimized.

FIG. 2 shows a package 50 in accordance with a second preferred embodiment of the present invention. The substrate 60 has an acoustic hole 66 in communication between the channel 62 and the space outside the cover 68 such that the acoustic single also can enter the accommodation chamber 64 to reach the single chip 70 through the acoustic hole 66 and the channel 62, thereby attaining the objective of the present invention.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A package for a MEMS microphone comprising:
a cover;
a substrate connected with said cover to define with said cover an accommodation chamber and having a channel in communication between said accommodation chamber and the space outside said cover; and
a single chip disposed in said accommodation chamber and electrically connected with said substrate and corresponding to said channel of said substrate.

2. The package as claimed in claim 1, wherein said cover has an acoustic hole in communication between said channel of said substrate and the space outside said cover.

3. The package as claimed in claim 1, wherein said substrate has an acoustic hole in communication between said channel of said substrate and the space outside said cover.
